(19) United States
(12) Patent Application Publication
(10) Pub. No.: US 2024/0359204 A1
(43) Pub. Date: Oct. 31, 2024

(54) APPLICATOR

(71) Applicant: CARLISLE FLUID TECHNOLOGIES, LLC

(72) Inventors: John Lastberg, Skovde (SE); Peter Alfredsson, Kallby (SE)

(21) Appl. No.: 18/037,539

(22) PCT Filed: Nov. 17, 2021
(86) PCT No.: PCT/US2021/059797

§ 371 Date: May 17, 2023

Related U.S. Application Data
(60) Provisional application No. 63/114,803, filed on Nov. 17, 2020.

(51) Int. Cl. B05B 15/652; B05C 11/10

(52) U.S. Cl. CPC B05B 15/652; B05C 11/1036

(57) ABSTRACT

A sealing applicator can include a central body; a swiveling chamber; and a connection housing, wherein the central body and the swiveling chamber comprise an axis configured to receive multiple materials, and wherein the axis is configured to dispense the materials at any of 360 degrees of rotation.

### PRIORITY

This application is a continuation of U.S. 63/114,803, filed 17 Nov. 2020, from which priority is claimed and is incorporated herein by reference.

### BACKGROUND

Disclosed herein is an applicator, and more specifically, a sealing applicator that can include a central body; a swiveling chamber, and a connection housing, wherein the central body and the swiveling chamber comprise an axis configured to receive multiple materials, and wherein the axis is configured to dispense the materials at any of 360 degrees of rotation.

### SUMMARY

A sealing applicator can include a central body; a swiveling chamber, and a connection housing, wherein the central body and the swiveling chamber comprise an axis configured to receive multiple materials, and wherein the axis is configured to dispense the materials at any of 360 degrees of rotation.

### BRIEF DESCRIPTION OF THE FIGURES

FIG. 1 is a non-limiting, exemplary view of the embodiments disclosed herein.

FIG. 2 is a non-limiting, exemplary exploded view of the embodiments disclosed herein.

FIG. 3 is a non-limiting, exemplary cutaway view of the central body of the embodiments disclosed herein.

FIG. 4 is a non-limiting, exemplary cutaway view of swiveling house the of the embodiments disclosed herein.

FIG. 5 is a non-limiting, exemplary cutaway view of the piston assembly of the embodiments disclosed herein.

FIG. 6 is a non-limiting, exemplary cutaway view of the connection housing of the embodiments disclosed herein.

FIG. 7 is a non-limiting, exemplary view of the seal assembly of the embodiments disclosed herein.

### DETAILED DESCRIPTION

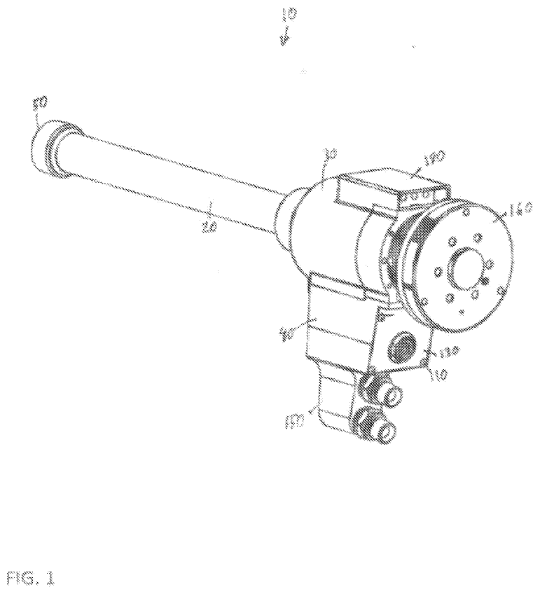

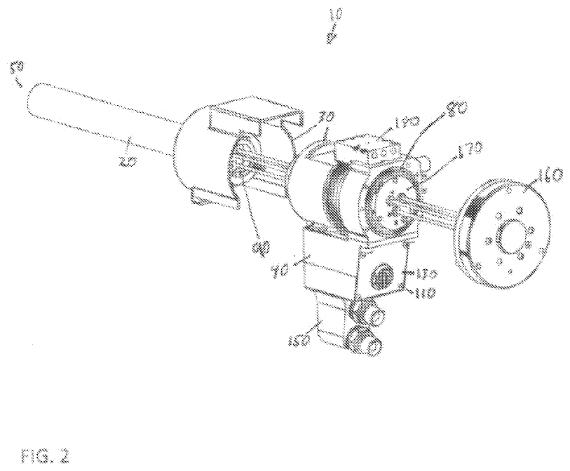

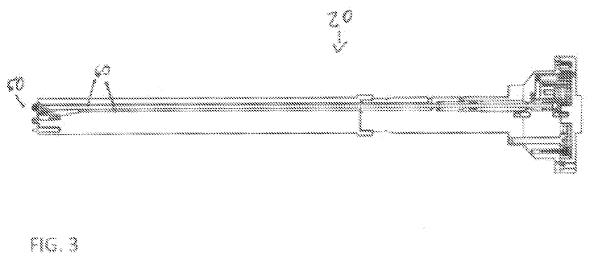

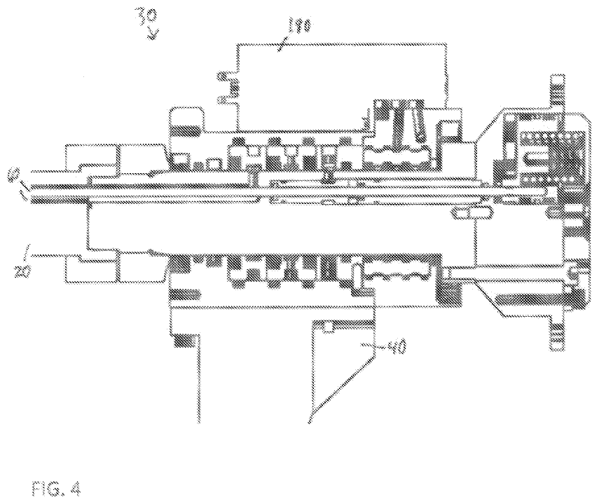

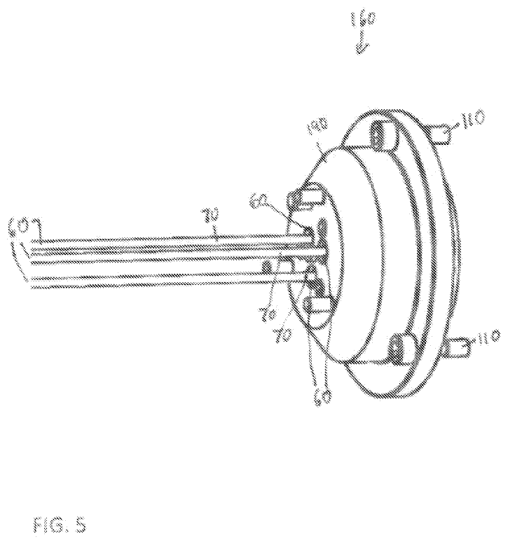

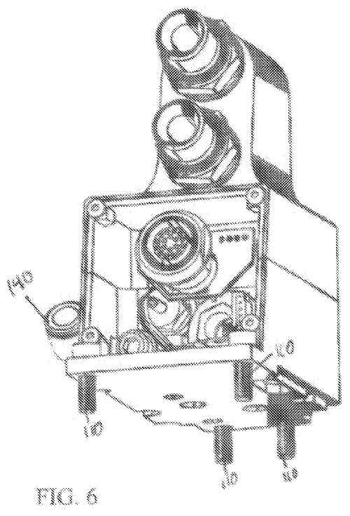

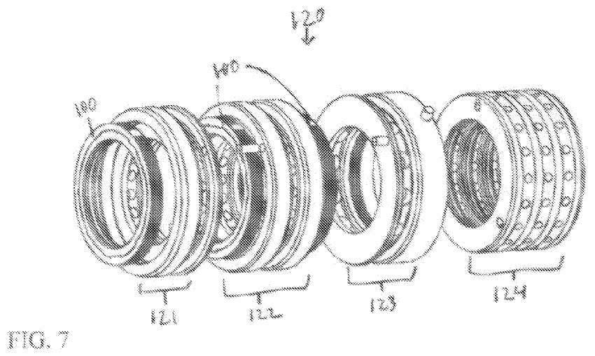

As shown in FIGS. 1-7, a sealing applicator 10 can include a central body 20; a swiveling chamber 30, and a connection housing 40, wherein the central body 20 and the swiveling chamber 30 comprise an axis 170 configured to receive multiple materials, and wherein the axis 170 is configured to dispense the materials at any of 360 degrees of rotation. In some embodiments, the central body 20 is configured to extrude the materials into a nozzle 50 head. In some embodiments, the central body 20 comprises a plurality of channels 60 and air-controlled pistons 70, wherein the air-controlled pistons 70 control the flow of the materials through the channels 60. According to certain embodiments, the central body 20 comprises three channels 60, wherein two of the channels 60 are configured to stream material toward the nozzle 50 head, and one channel is a return channel configured to receive a second material. According to certain embodiments, the swiveling chamber 30 comprises a ball bearing 80. In some embodiments, the swiveling chamber 30 comprises tracks 90 configured to fit with O-trings 100 inside the swiveling chamber 30. According to certain embodiments, the swiveling chamber 30 comprises a plurality of swivel chamber channels 60, wherein the swivel chamber channels 60 are segregated by a plurality of swivel chamber sealing rings. In some embodiments, the swiveling chamber 30 is a split chamber. In some embodiments, the split chamber is joined with a plurality of screws 110. According to certain embodiments, the swivel chamber is configured to comprise seal rings 120 to circulate materials within the central body 20. In some embodiments, the connection housing 40 is configured to transport the materials from a plurality of hoses to the swivel chamber. In some embodiments, the connection housing 40 comprises a leakage chamber 130 configured to receive any leakage of components from the swivel chamber. According to certain embodiments, the leakage chamber 130 is removably attached to a hose via a leakage chamber hose connection 140 configured to transport materials out of the applicator 10. In some embodiments, the connection housing 40 attachment to the swivel chamber consists of a plurality of screws 110. According to certain embodiments, the connection housing 40 comprises connection housing 40 tracks 90 configured to receive a protection cover 150.

According to certain embodiments, the applicator 10 can distribute 3D PVC material strings in different directions, and can rotate 360 degrees which makes almost all areas reachable for the product. In some embodiments the applicator 10 can alternate between lengths is useful to the customer. In some embodiments, two different materials can be inserted into the system and help the customer with applying different medias to various areas. In some embodiments, the applicator 10 can be configured with pressure and temperature sensors 180 to optimize their use.

In some embodiments, the central body 20 can be configured to distribute and extrude material into the nozzle 50 head and from there to a body framework. In some embodiments, material can be circulated inside the central body 20. By opening and closing pistons 70 controlled using air pressure, the material can be flowing through the channels 60 of the central body 20. There can be a total of three channels 60 where two of them are used as streaming the material towards the nozzle 50 head. One return channel can be arranged with a separate channel but can alternatively be managed to handle a second material. Due to multiple channels 60 and inlets to those channels 60 there can be a seal assembly 120 preventing the material from traveling to unwanted locations. In some embodiments central axis 170 can have an outer shell that is hardened to prevent those seals from wearing out. In some embodiments, the central body can be divided into several components. Dividing the central body 20 in three parts can enable material change in the central axis 170 and allows configuration changes to be made more quickly compared so a solid body central body 20. The steering of the applicator 10 can be configured inside the central body 20. The outer diameter of the needle can position according to the holes and edges designed in the central body 20. The connection between the central axis 170 and the central body 20 can be a cross solution which includes both accurate steering and contact pressure between the plane surfaces. The outer diameter of the axis 170 can be steering on the inner diameter of the central body 20. To make the surfaces close and seal, a locking ring can be used on top of the construction with multiple functions. The locking ring can have inner threads and the axis 170 has outer threads to fit. The locking ring can prevent the swiveling house from sliding off.

According to certain embodiments, the swiveling chamber 30 can be configured for material and air distribution, as well as tracks 90 for the O-trings 100 inside the chamber to get a fixed seal. The swiveling chamber 30 can be a split chamber, thereby allowing access to the accurate seal when necessary when performing a service. The swiveling chamber 30 can include a ball bearing 80.

The seal assembly 120 can be configured to seal around the central body 20, which can be rotating. The seals can be cylindrical. There are different details in the package handling different solutions. For example, the seal rings 120 between the material channels 60 can be dividing the two apart and separating the material flow. By removing or adding channels 60, a user can change the function of the applicator 10. The seals can be pressured axially while the material is pressured and therefore, the seal can become compressed against the central body 20 sleeve, thereby preventing the material from flowing underneath or over the seal. The higher the pressure on the material, the higher the compression of the seal ultimately becomes.

The seal assembly 120 cant now be divided into more blocks where the actual seal ring is assembled and integrated with an aluminum detail. In some embodiments, the seal assembly 120 can include a return ring, material ring, leakage ring, and air seal ring (121, 122, 123, 124, respectively), which are separate from one another. O-ring tracks 90 can be integrated with the swiveling chamber 30. It makes the O-trings 100 capable of preventing any material or air leakage. Seals can be integrated with aluminum rings to have better control of the compression and wear. Pin holes and pins can prevent rotation of the complete seal package. This will also increase the reliability of the endurance. In some embodiments, a U-manchette in the leakage ring can prevent material from reaching the air ring. The U-manchette is designed to keep the friction down while in contact with the axis 170. The U-manchette can be pressured/compressed.

The connection housing 40 can be configured to transport the material coming from the hoses into the applicator 10, as well as the angles and distances regarding the inlet/return lines.

The connection housing 40 can include a leakage chamber 130. If the internal seals in the swivel wear out the design will be able to lead the leaked material into this chamber and collect it. A hose on the side can then be able to lead the material out of the gun to a chosen container.

Tracks 90 in the bottom can be configured to make a protection cover 150 fit. The protection cover 150 is meant to handle labeling and keep the design smooth geometrically. The connection housing 40 can be removed from the assembly completely and on its own by removing a plurality of screws 110.

Sensors 180 can be used to measure and ensure he accurate temperature and pressure of the material. Sensors 180 can be placed inside the housing with an O-ring at the bottom. The valves configured to distributing air (approximately 5-8 bar) into the applicator 10 and to the pistons 70, opening and closing the needles. The valves can be integrated with an air distribution block.

The axis 170 can be configured to distribute both air and material flow through the applicator 10. The material (e.g., PVC) runs through and forward towards the head and the air backwards and into the cylinder 190 housing.

The cylinder 190 housing can connect to the central axis 170. Air can be pressed into three channels 60 where there are pistons 70. The pistons 70 then work up and down to open and close the flow to the nozzle 50 head. In some embodiments, the cylinder 190 housing can also connecting a flange to the applicator 10. In some embodiments, the flange can be unable to be in the central body 20, but in the cylinder 190 housing due to its extension. The cylinder 190 housing can include screws 110.

The piston assembly 160 can be configured for the opening and closing the supply of material (e.g., PVC) to the nozzle 50 head. In some embodiments, there can be space for an additional guidance ring to further stabilize a piston. There is also another space for adding another guidance ring. It will stabilize the piston even more.

While illustrative embodiments have been illustrated and described, it will be appreciated that various changes can be made therein without departing from the spirit and scope of the invention

We claim:

1. A sealing applicator comprising
a central body; a swiveling chamber; and a connection housing, wherein the central body and the swiveling chamber comprise an axis configured to receive multiple materials, and wherein the axis is configured to dispense the materials at any of 360 degrees of rotation.

2. The sealing applicator of claim 1,
wherein the central body is configured to extrude the materials into a nozzle head.

3. The sealing applicator of claim 2,
wherein the central body comprises a plurality of channels and air-controlled pistons, wherein the air-controlled pistons control the flow of the materials through the channels.

4. The sealing applicator of claim 3,
wherein the central body comprises three channels, wherein two of the channels are configured to stream material toward the nozzle head, and one channel is a return channel configured to receive a second material.

5. The sealing applicator of claim 1,
wherein the swiveling chamber comprises a ball bearing.

6. The sealing applicator of claim 1,
wherein the swiveling chamber comprises tracks configured to fit with O-rings inside the swiveling chamber.

7. The sealing applicator of claim 1,
wherein the swiveling chamber comprises a plurality of swivel chamber channels, wherein the swivel chamber channels are segregated by a plurality of swivel chamber sealing rings.

8. The sealing applicator of claim 1,
wherein the swiveling chamber is a split chamber.

9. The sealing applicator of claim 8,
wherein the split chamber is joined with a plurality of screws.

10. The sealing applicator of claim 1,
wherein the swivel chamber is configured to comprise seal rings to circulate materials within the central body.

11. The sealing applicator of claim 1,
wherein the connection housing is configured to transport the materials from a plurality of hoses to the swivel chamber.

12. The sealing applicator of claim 1,
wherein the connection housing comprises a leakage chamber configured to receive any leakage of components from the swivel chamber.

13. The sealing applicator of claim 12,
wherein the leakage chamber is removably attached to a hose configured to transport materials out of the applicator.

14. The sealing applicator of claim 1,
wherein the connection housing attachment to the swivel chamber consists of a plurality of screws.

15. The sealing applicator of claim 1,
wherein the connection housing comprises connection housing tracks configured to receive a protection cover.
